(19) United States
(12) Patent Application Publication
(10) Pub. No.: US 2010/0290875 A1
(43) Pub. Date: Nov. 18, 2010

(54) ENDLESS WHEELED RECEPTACLE TRANSPORTATION SYSTEM

(75) Inventors: Aaron Bruce Mawby, Western Australia (AU); Clinton John Giraudo, Western Australia (AU); Kimberley Vere Sadleir, Western Australia (AU); Nicholas Geoffrey De Vere Sadleir, Western Australia (AU)

Correspondence Address: BROOKS KUSHMAN P.C., 1000 TOWN CENTER, TWENTY-SECOND FLOOR, SOUTHFIELD, MI, 48075, US

(73) Assignees: Nicholas Geoffrey Devere Sadleir, North Fremantle, WA (AU); DEVERE MINING TECHNOLOGIES LIMITED, North Fremantle, WA (AU)

(21) Appl. No.: 12/530,310

(22) PCT Filed: Mar. 10, 2008
(86) PCT No.: PCT/AU08/00312

§ 371 Date: Apr. 14, 2010

(30) Foreign Application Priority Data
Mar. 8, 2007 (AU) 2007901191

(51) Int. Cl. B65G 67/02; B65G 67/24; B62D 63/06; B65G 67/04; B61B 13/00

(52) U.S. Cl. 414/376; 414/373; 280/400; 104/25

(57) ABSTRACT

A bulk materials transportation system having a plurality of carriages pivotally coupled endwise to form an endless chain of carriages, a rail track for guiding the carriages from a mine stockpile to a port stockpile, and a plurality of drive mechanisms located along the length of the rail track arranged for propelling the carriages. The rail track and the endless chain of carriages are substantially the same length. The drive mechanism is stationary with respect to the rail track. The carriages each have a coupling capable of allowing limited relative movement (including slack) with respect to endwise adjacent carriages to allow limited endwise movement between adjacent carriages to facilitate starting of the chain of carriages from a stationary condition.

### FIELD OF THE INVENTION

The present invention relates to a system for the transportation of bulk materials, such as, for example, mineral bearing ore, coal, mineral sands, woodchip, grain, soil and the like particulate material. The system is capable of transportation of bulk materials over distances less than a few kilometres (“short haul”). It is anticipated that the system could transport bulk materials over distances greater than 100 kilometres (“long haul”).

The bulk materials transportation system of the present invention is in the form of a continuous articulated rail in a tube (hereinafter referred to as the “CARIAT”). The system is of the nature of a conveyor, in that it has a ribbon in a continuous loop from a loading point to an unloading point and returns upside down. The system is also of the nature of a train, in that it has carriages connected endwise in an articulated manner for carrying discreet charges of the bulk material. The CARIAT has some characteristics that are similar to those of trains and some that are similar to conveyors. However, the CARIAT is neither a conveyor nor a train; it is a hybrid of a train and a conveyor. It takes some of the advantages of conveyors (in terms of small size and weight loadings) and some of the advantages of trains (in terms of rigidity and modular design and maintenance).

### BACKGROUND TO THE INVENTION

The CARIAT competes in the bulk materials transportation market, which is presently met by conveyors, rail, road vehicles and slurry pipelines (for overland haulage) and ships (for sea haulage).

There are a number of special purpose conveyors, including belt conveyors, chain conveyors; bucket conveyors; cable conveyors; teardrop conveyors; and tube conveyors. Road vehicles include road trucks, haul packs and other earthmovers—such as scrapers and front-end loaders. Rail transport uses rail trucks, including bottom dumping, side dumping and inverting types. Slurry pipelines are defined by the kinds of pumping mechanisms employed. And transport by sea includes ships and barges.

Nearly all of the world's overland long haul transportation is in two commodities, Iron Ore (approx. 1 billion tonnes per year) and Coal (approx. 4 billion tonnes per year). The transportation cost for these materials ranges from 10% to 65% of the sale price of those commodities.

In export markets, this transportation component is shared between shipping and land based transport, the proportion varying with geographic location, e.g. a Pilbara, Western Australian Iron Ore producer will get about AUD41 per tonne in Japan and pay around AUD4 per tonne for rail transport, plus a further AUD14 per tonne for shipping. The total transportation cost being AUD18 or 44%.

In large markets like China and the USA, this transportation is dominated by land based transport because the mine and customer are in the same country, e.g. a Western Region USA Coal producer gets USD24 per tonne in East Coast USA and pays USD12 per tonne for rail transport, representing a total transportation cost of 50%.

Around 95% of long haul overland transportation of bulk minerals is done by rail, with conveyors handling most of the remaining 5%.

The average overland cost of transportation is estimated at AUD4 per tonne for Iron Ore and AUD16 per tonne for Coal. This gives a current expenditure of about AUD4 billion per annum for Iron Ore and about AUD64 billion per annum for Coal. The combined market is thus AUD68 billion per annum.

### Bulk Transportation in the Mining Industry

We shall now examine the prior art in some detail to see how they compare with the CARIAT system.

Mining companies use one or more of the following bulk transport systems in their supply chain:
Trucks—including large, rear-loading dump-trucks on mines sites—and articulated road-trains.
Rail—including large diesel locomotives pulling trains of 100 to 300 ore wagons up to 7 km long, with payloads of up to 75,000 tonnes.
Conveyors—including overland multiple flight systems up to 100 km long—plus shorter loading conveyors at ports for blending from stockpiles and for out-loading directly on to very large ships.
Slurry pipelines—using water to carry ore in a pipeline over considerable distances up to 450 km.

Each of these current bulk transport systems has advantages and disadvantages compared to each other in various scenarios of the mining supply chain. Briefly, the advantages and problems of the prior art mining bulk transportation systems are as follows:

Trucks—offer flexibility, minimal capital investment (on a contractor basis), rapid expansion and contraction depending on production rates. On the downside, they are relatively expensive to operate, labour intensive, with significant environmental problems relating to dust, noise, visual pollution, road safety and community issues. Also, trucks are presently being faced with increasing operating costs in the form of increasing fuel prices, increasing licensing fees and lack of supply of tyres. Also, there are significant costs involved in construction and maintenance of roads required for the trucking activities. Where these costs are met by governments, trucks have a significant cost advantage over rail, but where the resource owner must bear the costs, rail has a distinct advantage.

Rail—currently rail offers the best long haul solution for large-scale transportation of bulk materials. The low rolling friction of steel wheels on steel rails (as low as 1/20th of road tyre friction) and reduced labour component make this possible. But the large-scale capital investment in rail and rolling stock (around AUD1 million to AUD2.4 million per kilometre) make the rail option generally only suitable where production exceeds 15 years, distance exceeds 100 kilometres and tonnages exceed 5 million tonnes/annum. In the case of Iron Ore, a typical maximum distance for rail haulage is about 600 km. For Coal (which has a much higher value) this maximum distance is up to about 3,000 km.

However, rail requires specialist engine drivers plus a host of maintenance specialists using large workshop facilities, plus high tech systems like mobile rail spectrometers etc. Also, rail uses considerable amounts of energy and cannot recover energy in downhill situations like a conveyor system can. Indeed a 350 km rail trip with 35,000 tonnes of iron ore will use around 20,000 litres of diesel.

Although relatively efficient for large tonnages, rail is not an optimum use of capital investment since the expensive rail line is only utilised when a train is travelling over it. For example, in the case of a fleet of 17 train consists, each 3 km long, operating on a 450 km single rail line with sidings, the utilisation is less than about 5% of the time. These inefficiencies can be improved by increasing the number of train consists—which requires a considerable increase in capital investment in rolling stock and requires a rail loop, in this case of 900 km length, so that trains can travel continuously without the need to pass each other in opposite directions.

Also, because of the very low utilisation of the rail system, when the trains do travel, they must be many times larger than would be the case if the train was an endless steam of carriages. Consequently, the rail systems must also be much heavier to cope with the higher loadings (around 13 tonnes per linear metre of rail track).

Further, due to the heavy wheel loadings, railway systems are very expensive to maintain, with track maintenance, repairs to ore cars, wheels, axles, plus regular replacement or upgrades of the diesel locomotives. These maintenance systems require a large labour force which typically accounts for up to 30% of the operating cost of a rail transport system for bulk materials.

Still further, rail can only travel up shallow grades (i.e. less than 1:200 when loaded) and cannot recover potential energy lost in a downhill passage for the return uphill journey. Also, rail requires very expensive earth works in routing over undulating terrain.

For their operation trains rely upon what is called “slack” or play between adjacent carriages. This allows a locomotive to start first one carriage and then the next and so on until the whole train is in motion—without having to start the entire load of the train in a single pull. This slack can be as much as 15 metres in a train of about 900 metres total length. The amount of slack can increase with wear. This variation in the length of the train can lead to what is known as “slack action” where delays in the train's braking systems leads to the head of the train slowing before its tail and a shockwave being produced as the carriages crash into each other as the leading carriage slows at a faster rate than the next carriage. In severe cases of slack action serious damage and personal injury to train crew result.

Hence, the use of slack in a train must be very carefully controlled. It is also one of the limitations on very long trains; especially where different parts of the train are experiencing differing terrain. Hence, it would be impractical to have a train of, say, 100 km length, since the slack action would become unmanageable and the train would destroy itself and most likely any crew on board. As at 2008 the longest reported trains are rarely longer than 7 km in length.

Conveyor Systems—Conveyors are large structures that require a high degree of engineering expertise in design and construction. They require careful alignment, plus steel supports usually set in concrete footings. Conveyors use a tensioned belt travelling over mechanical rollers. The conveyor belt is driven by very large electric motors and pulley systems at both ends.

Being an endless bulk transportation system, conveyors are cost efficient and less expensive to operate than trucks or rail over limited distances. The belt tension factor means that they are limited in distance and must be put in several flights to cover distances greater than about 30 kilometres. Conveyors can travel around gradual horizontal curves but typically have a very limited ability to turn corners. Although, certain specific purpose conveyors are very adept at negotiating sharp bends—but are not well suited to distances of many kilometres.

Compared to trucks, conveyors do not require large numbers of operating staff or maintenance personnel, but ongoing maintenance of belts and rollers is an expensive part of operating the system. For instance, maintenance staff have to constantly inspect conveyor systems, listening for noisy or damaged roller bearings. The conveyor belt travels over mechanical rollers, causing friction and wear. The rollers have a much higher rolling coefficient than steel rail wheels on steel tracks of trains (about 11 times higher).

Because of this higher friction, conveyors use more electricity, and electricity costs are the highest ongoing cost of operating a mining conveyor system. Capital costs are also high, usually AUD1 million-AUD2 million per kilometre, depending upon the capacity to be carried.

Conveyors are large, above-ground structures, visually unattractive, noisy, can be polluting with dust, can cause problems in environmentally sensitive areas, and be socially unacceptable in areas where they impact on communities, resulting in operation curfews when close to residences.

Chain Conveyors—Chain Conveyors typically use a chain for moving product from one location to another. In some cases, the links of the chain have flat plates fixed atop them for supporting the product. Typically, the plates are very wide with respect to their length (measured in the direction of travel of the conveyor). Chain conveyors are usually driven by sprockets at each end and return in the inverted position. They can traverse undulating terrain and turn corners. Chain conveyors are generally slow and move small quantities of materials over relatively short distances. Chain conveyors also suffer from being mechanically complicated, and have problems with uneven wear due to their plates being very wide compared to their length. Finally, chain conveyors are not suitable for conveying bulk materials.

Bucket Elevators—Are sometimes confused with chain conveyors since bucket elevators generally do include chains connecting buckets together in an endless arrangement around sprockets. Bucket elevators then have devices to control the orientation of the buckets during their passage along the extent of their travel from a loading region to an unloading region. Typically, the buckets spend a significant period of their travel upside down, although in some arrangements inversion is only momentary. Also, bucket elevators have mechanisms to ensure adjacent buckets overlap during filling, and further mechanisms to ensure adjacent buckets do not clash or become disoriented during the remainder of their travel.

Pan conveyors—Are also driven by chains and have segments that overlap and are wider than they are long. This arrangement has the disadvantage that pan conveyors tend to wiggle along their path of travel which leads to uneven wear. Pan conveyors are used where hot and abrasive materials must be handled—especially for cement clinker. By their configuration pan conveyors are slow and only suited to short lengths.

Slurry pipelines—Offer an alternative solution to rail where the ore being transported is relatively fine and can be suspended in a slurry. The Capital Cost is usually high and pumping costs are a significant operating expense. Such pipelines only suit a very small number of projects—especially steep downhill projects where the potential energy of the change in height provides sufficient pressure head to overcome the friction of the pipe. On flat land, the costs of pumping are considerable and wear and tear on pumps and pipes can be significant. There are few slurry pipelines in the world because of the high capital and operating costs. Slurry pipelines have found their niche where there are significant environmental issues such as noise, dust, safety and visual pollution grounds. Slurry pipelines also have the disadvantage that under new water conservation laws of many countries, the water used for the slurry must be returned to its point of origin—which further adds to the capital and operating cost of this form of bulk materials transport.

The CARIAT system of the present invention has some of the advantages of rail transport combined with the energy recovery advantages of conveyor systems, without the very high axle loads of rail and the high friction and wear rates of conveyors, resulting in very low cost per kilometre transport for bulk materials.

### SUMMARY OF THE INVENTION

Therefore, it is an object of the present invention to provide a bulk materials transportation system which incorporates an endless chain of carriages capable of transportation of bulk materials.

In accordance with one aspect of the present invention, there is provided a wheeled receptacle for a bulk materials transportation system, the wheeled receptacle including:

a coupling for endwise connecting of said wheeled receptacle to another similar said wheeled receptacle to form an endless chain of receptacles, the coupling being provided with slack to allow limited endwise movement of endwise adjacent wheeled receptacles to facilitate starting of the chain of receptacles from a stationary condition;
load bearing wheels for supporting said receptacle upon a guide means forming a substantially endless path; and,
guide wheels for maintaining said receptacle in longitudinal alignment with said guide means; and,
wherein the said receptacles are propelled by a drive means which is stationary with respect to the said endless path of the guide means.

In accordance with another aspect of the present invention, there is provided a system for transportation of bulk materials, the system including:

a plurality of wheeled receptacles coupled endwise to form an endless chain of receptacles, the wheeled receptacles each having a coupling provided with slack to allow limited endwise movement of each endwise adjacent wheeled receptacle to facilitate starting of the chain of receptacles from a stationary condition;
guide means for guiding the said endless chain of wheeled receptacles, the guide means forming a substantially endless path, the said path and the said chain of receptacles being substantially the same length;
loading means for loading the said wheeled receptacles;
unloading means for unloading the said wheeled receptacles; and,
drive means for propelling the endless chain of wheeled receptacles for transporting bulk materials from the loading means to the unloading means, the drive means being stationary with respect to the said endless path.

In accordance with yet another aspect of the present invention, there is provided a system for transportation of bulk materials, the system including:

a plurality of wheeled receptacles pivotally coupled endwise to form an endless chain of receptacles, the wheeled receptacles being coupled together such that they are capable of limited movement relative to each other, said limited movement including slack to allow limited endwise movement between adjacent wheeled receptacles to facilitate starting of the chain of receptacles from a stationary condition;

guide means for guiding the wheels of the said chain of wheeled receptacles, the guide means forming a substantially endless path, the path and the chain of receptacles being substantially the same length;
loading means for loading the said wheeled receptacles;
unloading means for unloading the said wheeled receptacles; and,
drive means for propelling the endless chain of wheeled receptacles for transporting bulk materials from the loading means to the unloading means, the drive means being situated at multiple locations along the length of the endless path, and said locations being stationary with respect to the said endless path.

Typically, the guide means is in the form of two rails arranged mutually parallel and disposed to support the wheels of the receptacles.

Typically, the system is provided with an elongate housing for covering the endless chain of receptacles. More typically, the elongate housing is a tube of substantially uniform cross-section.

Typically, the couplings for the receptacles allow for considerable variation in pitch between adjacent receptacles—to allow the receptacles to traverse hills and valleys.

Typically, the couplings for the receptacles allow for some variation in yaw between adjacent receptacles—to allow the receptacles to traverse corners.

Typically, the couplings for the receptacles allow for some variation in roll between adjacent receptacles—to allow the receptacles to traverse banked corners.

Typically, the diameter of the wheels is substantially the same as the height of the receptacles.

Typically, the receptacles are relatively long compared with their width. Typically, the receptacles are more than about 1 metre long and less than about 1 metre wide. More typically, the receptacles are more than about 1 metre long and less than about 0.7 metres wide. However, the receptacles could be much less than 1 metre long, such as, for example, around 0.5 metres long.

Typically, the loading means has a chute for discharging the bulk material into the receptacles.

Typically, the unloading means is in the form of an inversion module that allows the receptacles to invert lengthwise about the axes of the wheels.

Throughout the specification, unless the context requires otherwise, the word “comprise” or variations such as “comprises” or “comprising”, will be understood to imply the inclusion of a stated integer or group of integers but not the exclusion of any other integer or group of integers. Likewise the word “preferably” or variations such as “preferred”, will be understood to imply that a stated integer or group of integers is desirable but not essential to the working of the invention.

### BRIEF DESCRIPTION OF THE DRAWINGS

The nature of the invention will be better understood from the following detailed description of several specific embodiments of the Bulk Materials Transportation System, given by way of example only, with reference to the accompanying drawings, in which:

FIG. 1 is a schematic side view of a CARIAT conveyor system in accordance with one embodiment of the present invention, showing a chain of carriages transporting bulk material from one stockpile to another over an indeterminate distance;

FIGS. 2a and 2b are perspective views, from above and below, respectively, of a pair of guide and link carriages, of the CARIAT conveyor system of FIG. 1;

FIG. 3 is a perspective view, seen from above, of two guide carriages and one link carriage, of the CARIAT conveyor system of FIG. 1, shown traversing a steep downward curve;

FIG. 3a is a perspective view seen from above, of a wheel and axle assembly of the carriages of FIG. 3;

FIG. 4 is a perspective view, seen from above, of two tubes of the CARIAT conveyor system of FIG. 1, shown disposed above each other with a tower of blocks and with a single carriage located in each tube;

FIG. 4a is an end view of a rail of the tubes of FIG. 4;

FIG. 5 is a cross-sectional end view of the CARIAT conveyor system of FIG. 1 depicting the disposition of the CARIAT, respectively: A elevated above the ground; B set upon foundations; C set upon sleepers; D buried under a pile of earth above the ground; E buried under the ground in a trench; and F housed in a conduit under the ground;

FIG. 6 is a cross-sectional end view of the CARIAT conveyor system of FIG. 1 shown disposed in a conduit under ground and in comparison with a train and a belt conveyor of the same capacity;

FIG. 7 is a side view of the CARIAT conveyor system of FIG. 1 shown in comparison with a train and belt conveyor of the same capacity;

FIG. 8 is a cross-sectional end view of the bridging requirements for the CARIAT conveyor system of FIG. 1 shown in comparison with a train and belt conveyor of the same capacity;

FIG. 9 is a cross-sectional end view of the foundation requirements for the CARIAT conveyor of FIG. 1 shown in comparison with a train and belt conveyor of the same capacity;

FIG. 10 is a cross-sectional end view of the CARIAT conveyor system of FIG. 1 shown routed over a hill and in comparison with a train of the same capacity—the train requiring a significant cut-away; and,

FIG. 11 is a cross-sectional end view of the floodway requirements for the CARIAT conveyor system of FIG. 1 compared with the major earth works needed to support a train of the same capacity.

### DETAILED DESCRIPTION OF PREFERRED EMBODIMENTS

In the following exemplary embodiment, reference is made to the dimensions and some design particulars of the CARIAT as is appropriate for conveying around 10.5 million tonnes/year of coal over a distance of 4.5 kilometres at a speed of 4.0 m/s (14.4 kph). Although the CARIAT could transport more or less coal if operated at greater or lesser speeds, it is envisaged that the CARIAT could operate at speeds in excess of 10 m/s.

### CARIAT

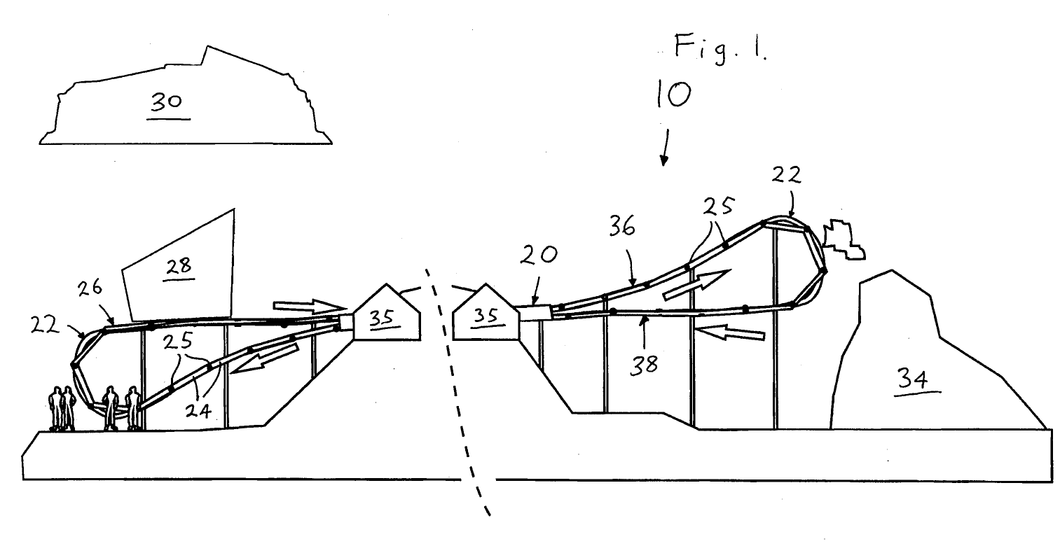

In FIG. 1 there is shown an arrangement of a bulk solids transport system herein referred to as a CARIAT 10 of the present invention as appropriate for a 4.5 km length of conveyor. The CARIAT 10 includes a conduit 20, a pair of rails 22 connected in an endless loop running through the conduit 20, a plurality of carriages 24 (with wheels 25) connected together endwise in a endless chain of carriages 26, a loading facility 28 located at a mine stockpile 30, an unloading facility 32 located at a port stockpile 34 and a plurality of drive units 35 (two of which are shown). The endless chain of carriages 26 is constituted by a load carrying part 36 and a return part 38, each being approximately half the length of the chain of carriages 26.

Whilst the CARIAT 10 is described with reference to a plurality of drive units 35, a short length CARIAT 10 could be made to operate with only one drive unit 35.

### Conduit

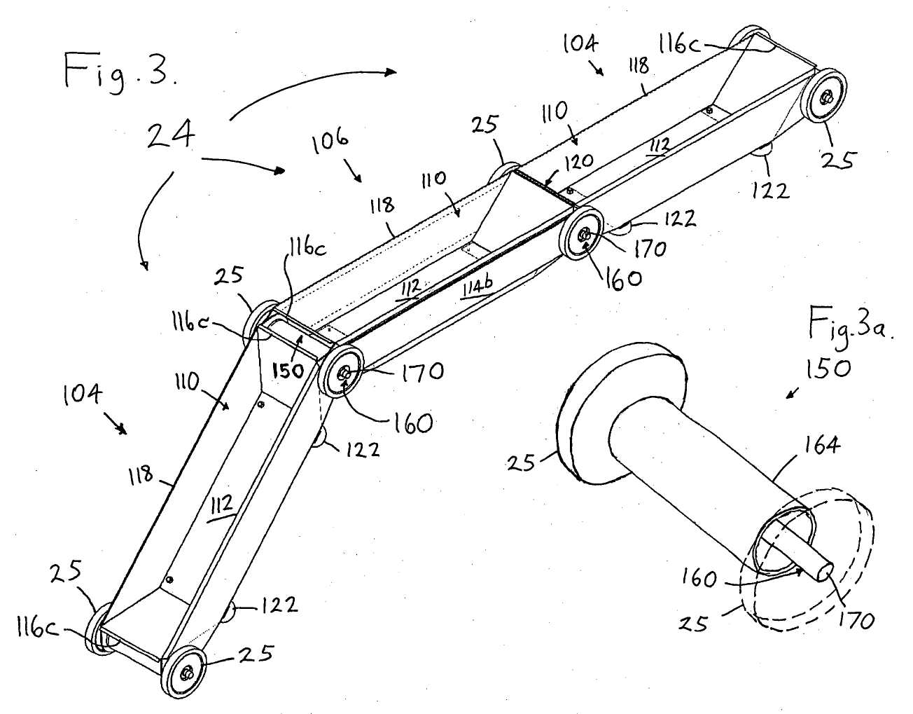

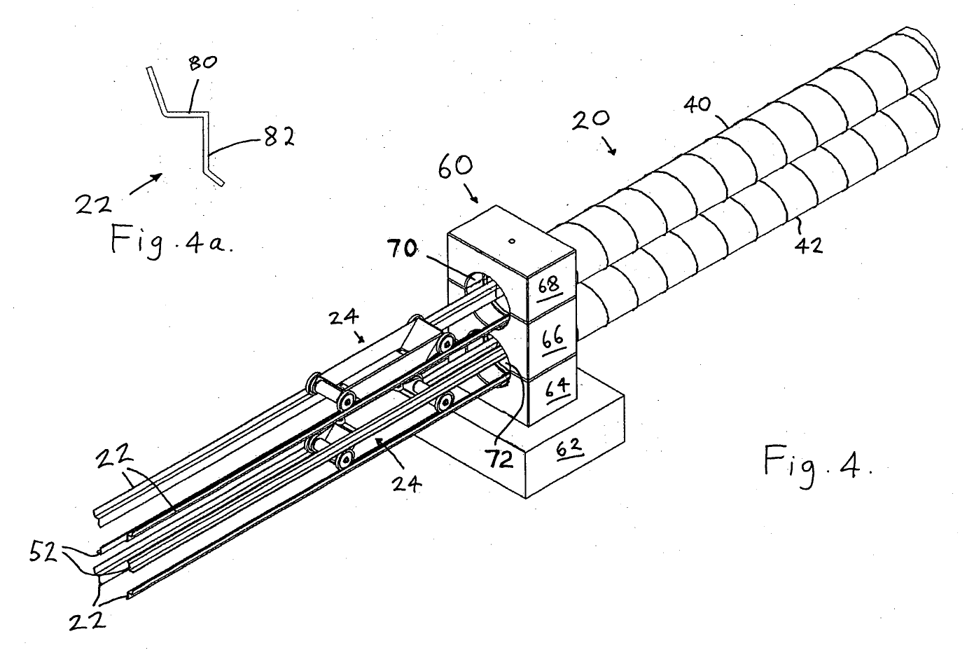

The conduit 20 is conveniently made from metal materials, such as, for example, steel. The conduit 20, as shown in FIGS. 3, 5a and 5b, is formed with an upper tube 40 and a lower tube 42, each circular in cross-section with a diameter of about 0.5 m. Typically, the tubes 40 and 42 have a wall thickness of between 0.5 and 3 mm. Conveniently, the tubes 40 and 42 are formed on site by wrapping in spiral lengths with adjacent edges of the spiral lengths crimped and sealed together. Multiples of the spiral lengths are then joined endwise to form the tubes 40 and 42. It is anticipated that the spiral lengths be about 8 metres long.

The tubes 40 and 42 are preferably circular in cross-section to allow for easier bending to follow contours of the land and to allow the CARIAT 10 to turn corners.

The spiral construction of the tubes 40 and 42 also lends itself to relatively easy curving—as compared to say a square or even a circular cross-section pipe.

The tubes 40 and 42 preferably have the same cross-sectional shape for ease of construction. The upper tube 40 carries the load carrying part 36 of the chain of carriages 26 and the lower tube 42 carries the return part 38 of the chain of carriages 26.

In the drawings, the tube 40 is shown spaced above the tube 42. However, this is not essential; the tubes 40 and 42 could be placed beside each other in spaced apart arrangement. In yet another arrangement, the two tubes 40 and 42 could be combined into one tube encasing both the load carrying part 36 and the return part 38 of the chain of carriages 26.

Alternatively, the tubes 40 and 42 could be formed with square, rectangular or even complex cross sections to more closely conform to the shape of the train of carriages 26. Accordingly, the tubes 40 and 42 could be made in the same manner as conventional pipes. In any event, it is preferred that the tubes 40 and 42 be able to prevent the ingress of the elements and to contain any dust produced by the transport of the bulk materials in the train of carriages 26.

Typically, the tubes 40 and 42 are received in and supported by blocks 60 conveniently made of cementaceous material such as structural concrete, provided with metals or plastics materials reinforcement. The supporting blocks 60 could be distributed periodically about every 8 to 18 metres or so along the length of the conduit 20 (to coincide with the length of the spiral lengths that make up the tubes 40 and 42). The blocks 60 are typically set upon footings 62.

The blocks 60 each comprise a base block 64 which sits atop the footing 62, a middle block 66 and an upper block 68. The base, middle and upper blocks 64 to 68 have cuts outs which combine together to form two passages 70 and 72 disposed transverse their length. The passages 70 and 72 receive the upper and lower tubes 40 and 42 respectively.

The supporting blocks 60 serve to help maintain the attachment and alignment of endwise adjacent spiral lengths of the tubes 40 and 42 and the rails 22.

Typically, support frames (not shown) are located intermediate adjacent blocks 60, longitudinally of the tubes 40 and 42, for supporting the tubes 40 and 42 and the rails 22 intermediate their length. The support frames are typically disposed about 2 metres apart and set upon concrete footings. Each support frame typically has two upwardly disposed posts interconnected by saddles to support the tubes 40 and 42. The posts also carry brackets that protrude into the tubes 40 and 42 to support the rails 22, to avoid'undue sag in the rails 22 between the adjacent blocks 60.

It is also to be noted that the tubes 40 and 42 could be replaced by open trusses. However, tubes 40 and 42 are typically used since they are enclosed to contain any dust, tend to confine noise and are cheaper to construct and install than trusses.

It is envisaged that the tubes 40 and 42 could be provided with hatches to allow accesses intermediate their length.

It is envisaged that the tubes 40 and 42 are unlikely to need to be greater than 1 metre wide for conveying most bulk solids up to 100 million tonnes per annum.

It is also envisaged that the tubes 40 and 42 could be laid side-by-side on the ground thus obviating the need for the support frames.

### Rails

The pair of rails 22 are arranged with each rail of the pair located substantially mutually parallel in both plan and elevation. Each rail 22 has a substantially horizontal ledge 80 and a substantially vertical guide 82. The ledges 80 are designed to support the wheels 25 of the carriages 24. For this purpose, the ledges 80 of the pair of rails 22 are substantially co-planar and mutually parallel. The guides 82 are disposed substantially vertically so as to mate with, or nearly mate with, guide wheels 122 of the carriages 24 to guide the carriages 24 along the rails 22, as described hereinafter.

As a result of the use of the guides 82, it is possible to rely on an un-cambered profile for the ledges 80 and the wheels 25 do not need to be tapered and the carriages 24 can still travel accurately along the rails 22. This is in sharp distinction to trains—which require profiled rails and tapered wheels to guide their carriages along the rails. The cambered profiles of rails and tapered wheels, used in train systems, dramatically reduce the load bearing area of the wheels on the rails, increase the point load of the carriages and increase the rate of wear experienced.

Due to the use of light loads and flat ledges, the wear of the wheels 25 and rails 22 in the instant invention is substantially less than would be the case if the art of train rail design were followed.

The rails 22 can be made of high tensile steel and formed integrally with or attached to the tubes 40 and 42. Alternatively, cushioning spacers could be used in securing the rails 22 to the tubes 40 and 42.

The rails 22 are typically made in lengths and joined in situ. For this purpose, the ends of the rails are aligned obliquely in the transverse direction so that the ends of endwise adjacent lengths of the rails 22 join at an oblique angle to the axis of the wheels 25 of the carriages 24, so that the contact area of the wheels over the wheel rails 22 is not subjected to an abrupt junction—which could otherwise lead to localised wear of both the carriage wheels 25 and the rails 22. The same oblique alignment is provided in the guides so that the guide wheels of the carriages 24 also are not subjected to an abrupt junction—which could otherwise lead to localised wear of both the guide wheels and the wheel rails 22. The oblique alignment also allows for some movement between endwise adjacent rails 22 with changes in temperature, whilst avoiding buckling of the rails 22 and also avoiding damage to the carriage wheels.

Alternatively, the lengths making up the rails 22 could be fused together endwise to form a continuous rail having no apparent join. Such a construction would require that path of the rail 22 to allow for expansion and contraction of the rails 22 without buckling.

In the upper tube 40, the guides 82 of the rails 22 are below the ledges 80, whereas in the lower tube 42, the guides 82 are located above the ledges 80, typically in the upper region of the lower tube 42.

It is envisaged that separate guide rails 52 be used in the lower tube 42. It is also envisaged that saddles could be disposed between the pairs of rails 22 and the guide rails 52 to maintain the relative spacing of the guide rails 52 above the rails 22. Such saddles would be required to substantially conform to the inner curved surface of the tubes 40 and 42, to avoid collision with the carriages 24.

### Carriages

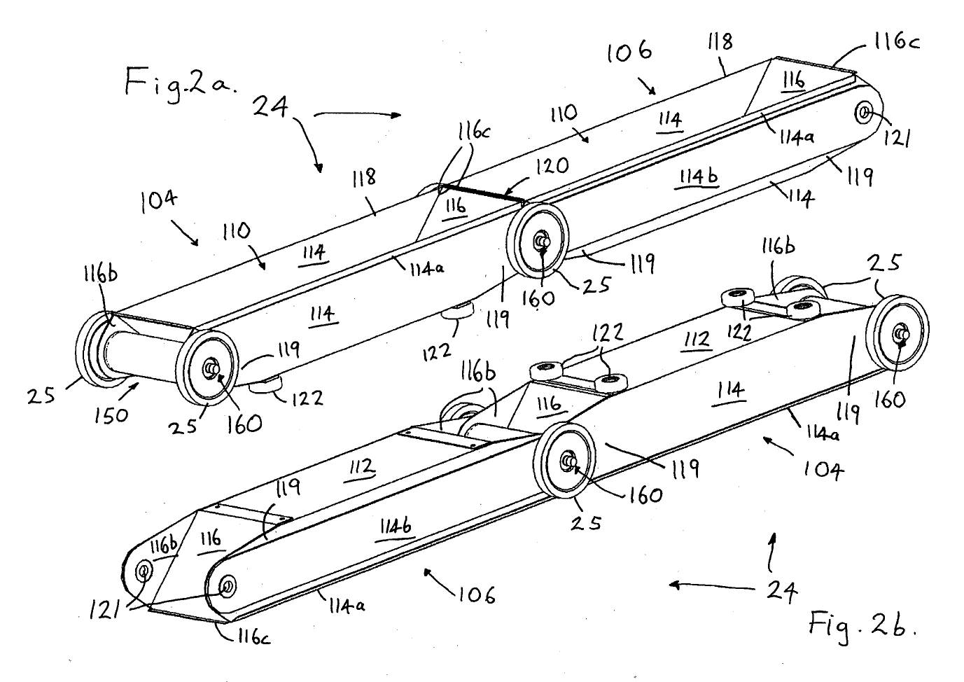

As shown in FIGS. 2a, 2b and 3 the wheeled carriages 24 are typically made in pairs, being a guide carriage 104 and link carriage 106. The guide carriage 104 is, in the exemplary embodiment, slightly narrower than the link carriage 106. The difference in the width of the two carriages 104 and 106 is a function of the way they are connected together. Hence, a different mode of connection could allow for all carriages 24 to be of identical shape and configuration. The carriages 24 are typically formed from metals materials, although it is to be understood that they could be formed in part from plastics materials or fibreglass or the like.

The carriages 24 are generally box shaped, with a carriage bin 110 which is generally rectangular in plan and end elevation, and trapezoidal in longitudinal cross-section. The carriage bin 110 has a base 112, two side walls 114, two end plates 116 and an open top 118. The trapezoidal shape is not critical to the function of the carriage bin 110, but is important for providing a space between adjacent carriages 24 for receiving a wheel and axle assembly 150—described hereinafter.

The carriage bins 110 may be provided with a liner or coating to provide protection from the potentially damaging effects of loading abrasive or rocky particulate material into the carriage 24. Such liners could be attached with fixings to the base 112, the walls 114 and the end plates 116 or with suitable adhesive. Liners may also be used when transporting corrosive materials, magnetic material and potentially explosive material (to reduce the incidence of sparks produced as the material is loaded into the carriages 24). Alternatively, the carriage bins 110 could be formed of plastics materials—such as, for example, carbon fibre reinforced nylon or the like engineering grade plastics.

The base 112 is generally rectangular and conveniently formed integrally with the side walls 114. The base 112 of the guide carriage 104 has four holes located proximate its longitudinal ends for mounting guide wheels 122. The link carriage 106 does not have such holes nor any guide wheels. However, in the event that the two carriages 104 and 106 have the same shape and configuration, one pair of the guide wheels 122 could be located on each of two carriages 104 and 106.

The side walls 114 depend upwardly from the base 112. Typically, the side walls are disposed vertically upwardly from the base 112, although this is not essential. However, it is preferred that the side walls 114 do not converge towards each other, since this could lead to bulk material becoming stuck in the carriages 24. The side walls 114 are generally rectangular and terminate at their longitudinal ends in flanges 119. The sided walls 114 also have a lip 114a at their upper edge for stiffening the side walls 114 against transverse loads.

Particularly as shown in FIG. 2b, the flanges 119 each has an aperture 121 disposed transversely so that two apertures 121 of opposing flanges 119 are centred upon the same axis. The pair of apertures 121 are thereby arranged to receive one of the wheel and axle assemblies 150. The apertures 121 also pass through the reinforcing bars 114b thereby providing added strength for the connection between the apertures 121 and the wheel and axle assemblies 150. Typically, the apertures 121 are further reinforced by a collar or the like formed through it and connecting the reinforcing bar 114b to the flange 119.

It is envisaged that the side walls 114 could have a profile which is other than planar so as to increase their ability to carry transverse loads.

The side walls 114 may also, or alternatively, have a reinforcing bar 114b extending along their length for increasing the amount of longitudinal load that the carriage 24 is capable of carrying. Such a reinforcing bar 114b is shown, just for convenience, in relation to the link carriage 106, but not in relation to the guide carriage 104.

In this manner the carriages 24 form the links of a chain with the reinforcing bars 114b being the link plates of the chain and the wheel and axle assemblies 150 being the pins and rollers of the chain. The difference to a chain is that the flexibility provided by the axle assemblies 150 allows yaw and roll so that the CARIAT 10 can follow a curved path.

Typically, the wheel and axle assemblies 150 allow about +5/−60 degrees in pitch, about +/−1 degrees in yaw and about +/−1 degrees of roll. Also, the 3 axes of pitch, roll and yaw are all in the same plane.

The end plates 116 are generally U-shaped and have a flange 116a conveniently spot welded to the base 112 between the two side walls 114. The end plates 116 also have flanges 116b arranged contiguous the flanges 119 and conveniently spot welded thereto. The spot welding of the flanges 116a to the base 112 and the flanges 116b to the flanges 119 of the side walls 114 has the effect of sealing the carriage bin 110 for carrying bulk solids. The end plates 116 are each also provided with a lip 116c, so that the lips 116c of pairs of adjacent carriages 24 form a shield 120 to shed particulate material into the carriage bins 110 and thereby inhibit the flow of particulate material between the carriages 24 during loading procedures. Typically, the end plates 116 are at an angle of about 45 degrees to the horizontal, although other angles of incidence could be used—provided there is enough space between endwise adjacent carriages for the wheel and axle assembly 150.

The open top 118 is formed of the lips 114a of the side walls 114 and the lips 116c of the end plates 116.

The guide carriage 104 is coupled to the link carriage 106 by the wheel and axle assembly 150. That is, each carriage 24 has only one wheel and axle assembly 150. The wheel and axle assembly 150 typically includes an axle assembly 152 and two wheel assemblies 154.

Particularly as shown in FIG. 3a, the axle assembly 150 includes a shaft 160 and a tubular housing 164. The shaft 160 is typically made from a solid rod of metals material and has a stub 170 at each end for receiving a bearing of the wheel assembly 150. The shaft 160 receives circlips, or ‘E’ clips or the like removable fasteners (not shown), for limiting the axial movement of the shaft 160 with respect to the carriages 24. The stub 170 has a smaller radius than the remainder of the shaft 160. The stub 170 is delineated from the remainder of the shaft 160 by a shoulder against which a bearing can rest and be held in place by a circlip.

The housing 164 of the axle assembly 152 is generally tubular with a constant cross-section and two open ends which bear against the flanges 119 of the carriages 24 to hold them apart.

It is envisaged that the interconnection of endwise adjacent carriages 104 and 106 allows for between about 1 and 2 mm of relative movement in the longitudinal direction (otherwise known as “slack”). In one possible form this movement can be provided for by making the holes 121 elliptical—the elliptical holes 121 being oriented in the direction of travel of the carriages 24. The elliptical holes 121 could also be curved in a downwardly directed crescent (like a banana) so as to urge the shaft 160 into its centre location with the force of the weight of the carriages 24. The relative movement of carriages 24 allows for progressive start-up of the CARIAT 10 from a stationary condition to full operating speed as the slack is taken up by each carriage 104 and 106 in turn. The movement of the shafts 160 in the elliptical holes 121 can also allow yaw and roll between endwise adjacent carriages 24. Yaw is necessary for the carriages 24 to be able to traverse a sweeping bend in the passage of the rails 22 between the mine and the port. Roll can also assist in the traversing of curved paths.

The wheel assemblies 154 include bearings and circlips to hold the bearings in place on the shaft 160. Typically, the wheel 25 is made of plastics materials, such as, for example, carbon fibre reinforced nylon or similar engineering grade plastics materials capable of carrying substantial loads and maintaining their shape and properties over a long period of time. The wheels 25 typically have a diameter of about 220 mm which is similar to the height of the carriages 24 and are about 30 mm wide. Conveniently, the wheels 60 have about 80% of their volume hollowed out. The wheels 60 are then preferably machined and balanced, if necessary, to ensure minimal irregularities in their shape and minimal vibration.

It is envisaged that the wheels 25 could alternatively be made of metals materials.

Conveniently, in the exemplary embodiment of the present example, the carriages 24 are roll pressed from steel plate with dimensions of 1,100 mm wide×2.2 mm thick and cut to 3,000 mm lengths and then formed into a box shape and welded along open joins. Hence, each carriage 24 has a height of about 210 mm and a width of about 250 mm and a length of about 1,000 mm.

It is to be noted that other dimensions could be used. For example, the thickness of the material could be more or less than 2.2 mm, such as, for example, 1.6 mm. The length, height and width of the carriages 24 could be changed to suite differing bulk solids materials to be transported and so suite different tonnages. It is envisaged that very small carriages less than 100 mm wide, 80 mm high and 500 mm long could be used for transporting small quantities of bulk solids—such as, for example, less than 2 million tonnes per annum. Similarly, large carriages, greater than 600 mm wide, 480 mm high and 2,000 long, could be used for transporting large quantities of bulk solids—such as, for example around 100 million tonnes per annum.

### Drive Units

The drive units 35 include mechanisms which are capable of capturing the stubs 170 of the shafts 160 of the axle assemblies 150 and propelling them in the direction of travel of the carriages 24. The drive units 35 are spaced periodically along the length of the tube 20. At the location of each drive unit 35, the tube 20 is made open to allow access to the axle stubs 170.

Conveniently, each drive unit 35 includes a chain having a plurality of capture members located along its length and disposed transverse its direction of travel. The capture members are shaped to receive the axle shafts 170 for capturing the axle stub 170 of two or more adjacent carriages 24.

The chain of the drive unit 35 is conveniently driven by an electric motor. The motors of all of the drive units 35 along the length of the tube 20 are controlled so as to operate substantially in unison so as to avoid differing load tensions in the chain of carriages 26. The drive units 35 are typically disposed along the chain of carriages 26 at locations that ensure that the tension on the chain of carriages 26 between any two adjacent drive units 35 is substantially the same. Hence, where the tube 20 is laid uphill, the drive units 35 may be located closer together, where the tube 20 is laid downhill the drive units 35 may be located further apart (provided the slope is not so great as to require breaking in normal operation) and where the tube 20 is laid over a substantially horizontal plane, the drive units 35 may be located at an intermediate distance apart.

It is envisaged that the drive units 35 could be placed between 20 metres and 2,000 metres apart, depending upon the terrain, the power of the drive units 35 and the amount of tension the chain of carriages 26 is able to carry. It is estimated that with the drive units 35 located 2,000 metres apart, there would be less than around 20 tonnes of tension in the chain of carriages 26 due to friction and drag—which means that each carriage 24 must be constructed to be able to transmit at least 20 tonnes of load in a longitudinal direction along each of its two longitudinal sides. This assumes a moving mass of less than about 0.5 tonnes per linear metre of rail 22.

### Loading Facility

As shown in FIG. 1, the loading facility 28 is conveniently in the form of a chute, such as, for example, a so called “banana chute”. The loading facility 28 delivers ore from the stockpile 30 to the carriages 24.

It is envisaged that other forms of loading facility 28 could also be used.

### Unloading Facility

Also, as shown in FIG. 1, the unloading facility 32 is conveniently in the form of a loop disposed about a horizontally axis. The loop allows for the carriages 24 to pass over it from its upper surface to its lower surface. As this transition occurs the carriages abruptly change direction from forward motion to downward motion and then to motion in the reverse direction. This results in the bulk solids in the carriages 24 substantially maintaining their momentum (speed and direction) which causes the bulk material to exit the carriages.

Typically, the exiting bulk material is collected in a chute and directed onto a conveyor belt for conventional delivery to the stockpile 34.

### Cleaning

The carriages 24 returning in the return part 38 of the chain of carriages 26 typically travel upside down and are typically cleaned with high pressure air and optionally water to ensure that there is no bulk material adhered to the carriages 24 in the return part 38.

Typically, the CARIAT 10 is provided with a cleaning system to ensure that the tube 20 does not fill up with dust or other material. The cleaning system could be in the form of a vacuum cleaner system located in the chain of carriages 26. More than one vacuum cleaner could be used depending upon the length of the CARIAT 10.

### ADVANTAGES

The CARIAT 10 has advantages including low rolling friction, high energy efficient and its capacity can readily be varied. The CARIAT 10 also solves most of the problems associated with rail in that it represents good use of capital (about 60% or less of the cost of equivalent train carrying capacity), requires only low levels of maintenance and personnel, can travel up and down relatively high grades (i.e. 1:10 when loaded) and can recover potential energy lost in a downhill passage for the return uphill journey. Also, the CARIAT 10 requires only minimal earth works in routing over undulating terrain. Because the CARIAT 10 is an endless stream of carriages, it can be much smaller than a train of comparable transport capacity. Consequently, the CARIAT 10 can be much lighter to cope with the lighter loadings (typically around 300 to 500 kg per metre, and not likely to be more than 800 kg/m). Also, the CARIAT 10 requires less structural support, e.g. reduced need for sleepers, bridges, ballast and supporting earth works.

The CARIAT system 10 is a very light rail system compared to those of ore transport railway systems. On some heavy duty rail wagons, the two large four wheeled bogies carry a total mass of 160 tonnes. This mass is shared 40 tonnes per axle compared with typically not more than around 800 kg/axle for the CARIAT system 10 of the same transport capacity, which represents less than 1% of the structural load of the railway wagon.

The axle assembly 150 allows the carriages 24 to move relative to each other, which is important in inverting and turning corners and starting movement of the carriages 24. In this case, about +5/−60 degrees in pitch, about +/−1 degrees in yaw and about +/−1 degrees of roll.

The CARIAT 10 differs from chain conveyors in that it is capable of much greater speeds, is simple in design, is capable of pitch, roll and yaw (this means the CARIAT 10 can twist and turn corners as well as traversing undulating terrain). Also, because the carriages 24 in the CARIAT 10 are narrow compared to their length, the problems of uneven wear are largely eliminated and use relatively few rail engaging wheels when compared to a chain conveyor of the same length. The maximum practical length of a chain conveyor is about 2 kilometres, whereas the CARIAT 10 can be many hundreds of kilometres long. The CARIAT 10 is generally enclosed by the conduit 20 which replaces the bulky and complicated structural support of the conventional chain conveyor. Also, the CARIAT 10 is generally much smaller in height and width than a chain conveyor of the same capacity. Typically, chain conveyors are several metres wide, whereas an equivalent CARIAT 10 conveyor is around 0.8 metres wide or less.

One of the main advantages of the CARIAT 10 compared to conventional belt conveyors is its ability to use hard plastics material wheels 180 on steel rails 22 and consequently get the benefits of the very low rolling friction coefficient currently only enjoyed by railways and chain conveyors.

On a conventional conveyor, energy is a substantial cost. The CARIAT 10 addresses this problem by using hard wheels with a coefficient of rolling friction of about 0.003. This compares to the rolling coefficient for conventional belt conveyors ranging from 0.011 to 0.02; or 3.6 to 6.6 times greater than the hard plastics material wheels on steel rails. Which means that the power required to drive the carriages 24 is around to 30% of that required to drive a belt conveyor of similar capacity.

Further, as shown in FIG. 5, the CARIAT 10 can be installed on the ground, in the ground and above ground (labelled A to F). In FIG. 5, label A the CARIAT 10 conduit 20 is elevated above the ground—such as for traversing marshy or flood prone land or across water courses or into oceans. In FIG. 5, label B the conduit is set upon foundations, such as made from cementaceous material. In FIG. 5, label C the conduit 20 is set upon sleepers. In FIG. 5, label D the conduit 20 is buried under a pile of earth above the ground. In FIG. 5, label E the conduit 20 is buried under the ground; and in FIG. 5, label F the conduit 20 is housed in a tunnel under the ground.

The underground options labels D to F are preferred for the CARIAT 10 to help control expansion and contraction of the tubes 40 and 42. Where the tubes 40 and 42 are exposed above ground (labels A to C), the tube 40, 42 temperature could vary from −10 degrees C. up to +80 degrees C. In this situation, a continuous length of tube would expand in length by about 1 metre/kilometre. By burying the tube 40, 42 the temperature range may be limited to around 20 degrees. In these conditions, the friction force on the walls 82 of the tube 40, 42, which is estimated at around 500 t/km, far exceeds the estimated expansion force. That is to say, a buried CARIAT 10 is unlikely to experience any change in length with temperature—which is preferred. In the event that above ground sections are required, it is envisaged that the conduit 20 could be curved gently along its path of travel to take up any increase in length, as sideways movement of the conduit 20.

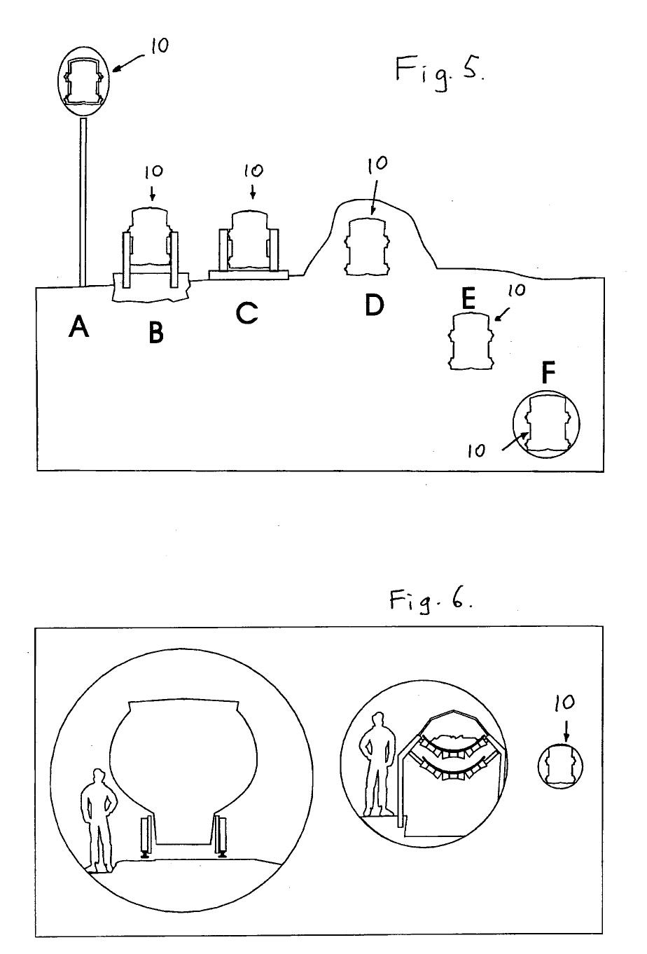

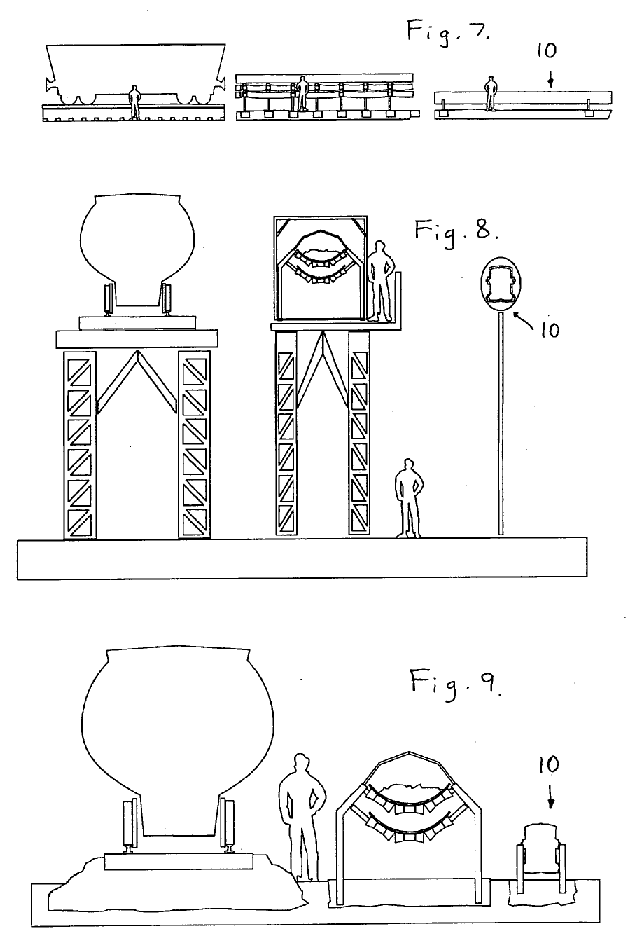

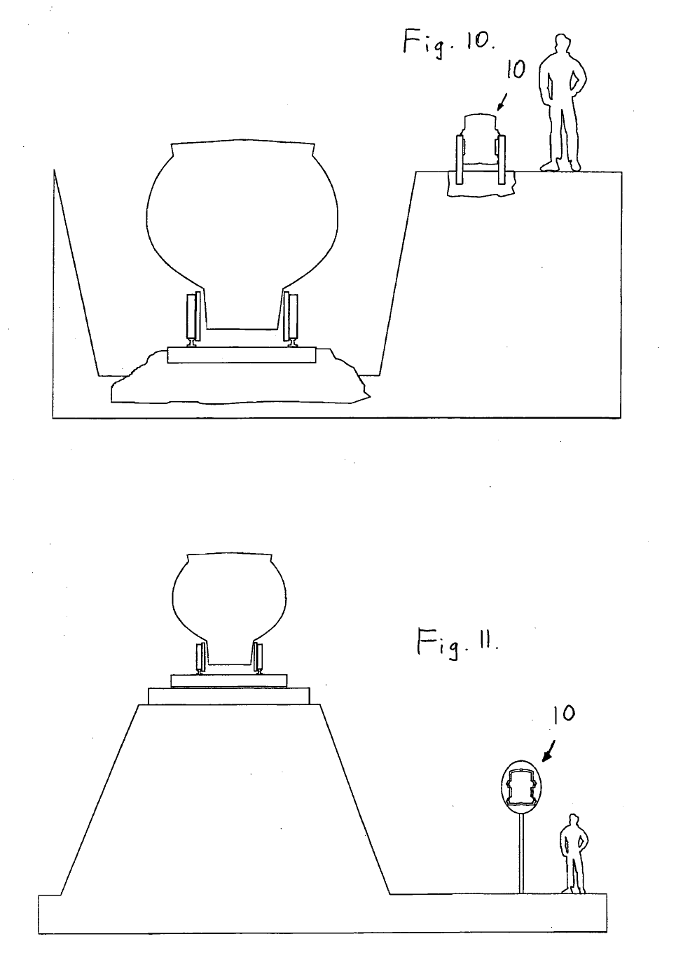

In FIGS. 6 to 11 there is a to-scale comparison of the installation requirements of the CARIAT 10 of the present invention as compared to rail and conventional belt conveyor transport. In FIG. 6 the CARIAT 10 has the smallest tunnel requirements since it does not need human access for maintenance. In FIG. 7 the CARIAT 10 has the smallest profile and hence represents the smallest impact on the landscape and requires the least amount of footings. FIG. 8 indicates the considerable savings in capital cost associated with bridging using the CARIAT 10. FIG. 9 shows that the CARIAT 10 has the smallest foundations, since it has the smallest weight to support per unit length and the narrowest displacement. FIG. 10 shows that the CARIAT 10 can avoid the use of costly cutaways through has required by trains. And FIG. 11 shows the considerable saving the CARIAT 10 installation has in materials required to traverse flood prone land, where trains require substantial earth works and culverts to allow the passage of flood waters. Also, the embankments used to support the trains are still prone to being washed away in large floods.

### Features of the Technology

Listed below are the superior technical features of the CARIAT 10:

1. Low Environmental Impact—Capable of travelling through environmentally sensitive areas, safely and quietly by running underground and eliminating noise, dust and other environmental impacts. The CARIAT 10 has a reduced impact on wildlife and flora and a relatively high social acceptance since it minimises impact on existing communities.
2. Very Low Energy Consumption—This is due to the low rolling friction from steel wheels on steel rails. The CARIAT 10 uses around 1/7th of the energy of a standard belt conveyor.
3. Labour Savings—The CARIAT 10 has fully automated continuous systems requiring only minimal operational staff.
4. Low Capital and Maintenance Costs—Fully enclosed systems simplify maintenance cycles, whilst low axle loadings greatly reduce strength requirements and wear on components. Hence, the combined capital and operating cost of the CARIAT 10 is around ⅓rd to ¼th that of conventional belt conveyors or railways, and around 1/10th the cost of trucking.
5. High Capacity—Capable of transporting tonnages ranging in the order from 100,000 tonnes per annum to over 100 million tonnes per annum.
6. Long Range—Capable of transporting bulk solids over distances ranging from as low as 0.1 km to over 500 km.
7. Compact Design—A very compact cross-section design, giving low manufacturing and installation costs and ease of handling.

A number of detailed first order costings of the CARIAT System 10 indicate very substantial operating and capital cost savings over ALL other mining bulk handling land transport systems, i.e. conveyors, rail and trucking. The following table shows a general comparison between the projected costs of the CARIAT System and those of other bulk handling systems:

| | Cost per Tonne Kilometre |
|---|---|
| Bulk Handling System | (AU cents) |
| Trucking | 4 to 8 |
| Rail and Conveyors | 2 to 4 |
| CARIAT System | 0.1 to 2.5 |
| Sea Shipping | 0.1 to 0.2 |

Modifications and variations such as would be apparent to a skilled addressee are considered within the scope of the present invention. For example, the conduit 20 could be of other shapes and/or made of other materials. The carriages could have other relative dimensions and could be made of other materials, such as, for example, plastics materials.

1. A bulk materials transportation system, the system including:
a plurality of wheeled receptacles coupled endwise to form an endless chain of receptacles, the wheeled receptacles each having a coupling provided with slack to allow limited endwise movement of each endwise adjacent wheeled receptacle to facilitate starting of the chain of receptacles from a stationary condition;
guide means for guiding the said endless chain of wheeled receptacles, the guide means forming a substantially endless path, the said path and the said chain of receptacles being substantially the same length;
loading means for loading the said wheeled receptacles;
unloading means for unloading the said wheeled receptacles; and,
drive means for propelling the endless chain of wheeled receptacles for transporting bulk materials from the loading means to the unloading means, the drive means being stationary with respect to the said endless path.

2. A bulk materials transportation system, the system including:
a plurality of wheeled receptacles pivotally coupled endwise to form an endless chain of receptacles, the wheeled receptacles each having a coupling capable of allowing limited relative movement of said wheeled receptacles relative to each other, said limited movement including slack to allow limited endwise movement between adjacent wheeled receptacles to facilitate starting of the chain of receptacles from a stationary condition;
guide means for guiding the wheels of the said chain of wheeled receptacles, the guide means forming a substantially endless path, the path and the chain of receptacles being substantially the same length;
loading means for loading the said wheeled receptacles;
unloading means for unloading the said wheeled receptacles; and,
drive means for propelling the endless chain of wheeled receptacles for transporting bulk materials from the loading means to the unloading means, the drive means being situated at multiple locations along the length of the endless path, and said locations being stationary with respect to the said endless path.

3. A bulk materials transportation system according to claim 1, in which the guide means is in the form of two rails arranged mutually parallel and disposed to support wheels of the receptacles.

4. A bulk materials transportation system according to claim 1, in which the system is provided with an elongate housing for covering the endless chain of receptacles, more typically, the elongate housing is a tube of substantially uniform cross-section.

5. A bulk materials transportation system according to claim 1, in which the unloading means is in the form of an inversion module that allows the receptacles to invert lengthwise about the axes of the wheels of the receptacles.

6. A bulk materials transportation system according to claim 1, in which the couplings allow for variation in pitch between adjacent wheeled receptacles, whereby the wheeled receptacles can traverse undulating terrain.

7. A bulk materials transportation system according to claim 1, in which the couplings allow for variation in yaw between adjacent wheeled receptacles, whereby the wheeled receptacles can traverse horizontal bends.

8. A bulk materials transportation system according to claim 1, in which the couplings allow for variation in roll between adjacent wheeled receptacles, whereby the wheeled receptacles can traverse banked corners.

9. A bulk materials transportation system according to claim 1, in which the diameter of the wheels is substantially the same as the height of the wheeled receptacles.

10. A bulk materials transportation system according to claim 1, in which the wheeled receptacles are relatively long compared with their width.

11. A wheeled receptacle according to claim 10, in which the wheeled receptacles are more than about 1 metre long and less than about 1 metre wide, more typically, more than about 1 metre long and less than about 0.7 metres wide.

12. A wheeled receptacle for a bulk materials transportation system, the wheeled receptacle including:
a coupling for endwise connecting of said wheeled receptacle to another similar said wheeled receptacle to form an endless chain of receptacles, the coupling being provided with slack to allow limited endwise movement of endwise adjacent wheeled receptacles to facilitate starting of the chain of receptacles from a stationary condition;
load bearing wheels for supporting said receptacle upon a guide means forming a substantially endless path; and,
guide wheels for maintaining said receptacle in longitudinal alignment with said guide means; and,
wherein the said receptacles are propelled by a drive means which is stationary with respect to the said endless path of the guide means.

13. A wheeled receptacle according to claim 12, in which the couplings allow for variation in pitch between adjacent wheeled receptacles, whereby the wheeled receptacles can traverse undulating terrain.

14. A wheeled receptacle according to claim 12, in which the couplings allow for variation in yaw between adjacent wheeled receptacles, whereby the wheeled receptacles can traverse horizontal bends.

15. A wheeled receptacle according to claim 12, in which the couplings allow for variation in roll between adjacent wheeled receptacles, whereby the wheeled receptacles can traverse banked corners.

16. A wheeled receptacle according to claim 12, in which the diameter of the wheels is substantially the same as the height of the wheeled receptacles.

17. A wheeled receptacle according to claim 12, in which the wheeled receptacles are relatively long compared with their width.

18. A wheeled receptacle according to claim 17, in which the wheeled receptacles are more than about 1 metre long and less than about 1 metre wide, more typically, more than about 1 metre long and less than about 0.7 metres wide.
